(19) United States
(12) Patent Application Publication
(10) Pub. No.: US 2021/0252528 A1
(43) Pub. Date: Aug. 19, 2021

(54) AUTOMATED DRY GRANULAR MATERIAL DISPENSER

(71) Applicants: WILLIAM J. STEINGRANDT, Travelers Rest, SC (US); John Dill, Hendersonville, NC (US)

(72) Inventors: WILLIAM J. STEINGRANDT, Travelers Rest, SC (US); John Dill, Hendersonville, NC (US)

(21) Appl. No.: 16/794,433

(22) Filed: Feb. 19, 2020

(51) Int. Cl. B05B 1/30; G01F 11/00; G01F 11/02; B65G 65/32; A01G 9/08

(52) U.S. Cl. CPC B05B 1/3026; G01F 11/003; G01F 11/02; B65G 65/32; B65G 2203/042; A01G 9/088; B65G 2201/0235; B65G 2203/0233; A01G 9/081

(57) ABSTRACT

An automatic dry material dispenser for dispensing dry material such as fertilizer to pots or other containers passing by on a conveyor. The device is controlled by a photo-detector or mechanical switch to dispense material when the container is in the proper position. The device consists of a material reservoir, a flexible feed hose, a pipe and elbow which can be pivoted by an electric solenoid and electronics for control. As the pipe and elbow are pivoted to a stop by the solenoid material is expelled from the elbow and down into the passing pot. The amount of material dispensed is controlled by an insert-able cylinder and by selecting the number of dispensing cycles per pot.

### FIELD OF THE INVENTION

The present invention relates to an automatically actuated dry material dispenser capable of applying a measured amount of fertilizer, herbicide, insecticide, or other like material to potted plants passing on a conveyor or by moving the actuator past stationary potted plants. Previous mechanisms for such application have been prone to clogging, overly complicated, or posed a risk of damage to the material or applied product.

### BACKGROUND OF THE INVENTION

Large plant nurseries will pot thousands of plants using an automated potting machine. In order to maintain a correct level of nutrients for the plant nurseries will apply time release dry fertilizers or other materials such as herbicides to the soil surface. In the past methods for such application included manual application using a cup or spoon, requiring an additional manual operation.

Existing applicators used by plant nurseries are prone to jamming, clogging, or are difficult to use efficiently. Many applications have multiple parts, require a blower or other power source and thus are expensive to both operate and manufacture. A large number of existing patents disclose a variety of dispensing methods. Each method requires manually or electronically operated valve(s) or else does not control the amount of material dispensed. Many existing applicators do not adapt easily to automatic actuation.

A first example is U.S. Pat. No. 2,772,815 Dec. 4, 1956 (Bye) which teaches a rotating paddle wheel for metering controlled amounts of material for application. This method is subject to clogging and jamming and also may damage fragile coatings on time-release fertilizers. There is no teaching of automatic actuation.

U.S. Pat. No. 5,339,994 Aug. 23, 1994 (Nulla) shows a dual valve system for metering fixed amounts for application. Again this approach may harm coatings and is subject to jamming from material build-up. This device does not lend itself to automatic actuation.

U.S. Pat. No. 7,641,082 B2 Jan. 5, 2010 (Seton) has an electronically operated valve for dispensing a controlled amount of material. This device is available for automatic actuation, however the use of a microprocessor and other electronics for control makes the manufacture of this device relatively expensive. Also a mechanically operated valve can still damage coatings.

Other patents reviewed were U.S. Pat. No. 4,387,852 Jun. 14, 1983 (Mattson, et. al.), U.S. Pat. No. 5,101,744 Apr. 7, 1992 (Nolan), U.S. Pat. No. 5,431,115 Jul. 11, 1995 (Auer), and U.S. Pat. No. 4,934,288 Jun. 19, 1990 (Kusiak, et. al.). These patents mentioned herein are all incorporated by reference.

As seen above, there are a variety of dry material applicators that have been disclosed. Each device may be prone to clogging or jamming, may not accurately meter the correct amount of material, may damage material by mechanically closing a valve, or may be costly to manufacture. An ideal dispensing apparatus would be simple with few moving parts, gentle on the dispensed material, resist clogging and jamming, able to dispense a wide variety of dry materials, and be easily automated.

Accordingly, there remains room for improvement and variation within the art.

### SUMMARY OF THE INVENTION

It is one aspect of at least one of the present embodiments to provide an automatic dispensing device for dispensing dry material, the device comprising:

a rigid pipe and elbow oriented at an angle to the horizontal able to be pivoted about an axis between two stops; a solenoid for causing the pipe and elbow via a lever to pivot between the stops when actuated;

a flexible hose to feed material into the pipe and elbow from a material reservoir;

an upper stop and lower stop situated such that material in the elbow will be expelled when the pivoting pipe hits the upper stop;

a photo-detector to detect pots or other containers moving by on a conveyor;

a removable dose restriction cylinder to change the inside diameter of the open of the elbow.

It is another aspect of at least one embodiment of the invention to provide a dispensing device wherein the rigid pipe and elbow is rotatable about an axis between a lower stop and an upper stop.

It is another aspect of at least one embodiment of the invention to provide a dispensing device having an electric solenoid able to pivot the pipe and elbow about an axis through a lever and linkage. The solenoid able to rapidly rotate the pipe and elbow to the upper stop to expel material from the elbow when hitting the upper stop, the material then exiting the device into a pot

It is another aspect of at least one embodiment of the invention to provide a dispensing device having a removable dose adjustment cylinder to change the inside diameter of the open end of the elbow to allow changing the amount of material dispensed per dose.

It is another aspect of at least one embodiment of the invention to provide a dispensing device for dry material comprising;

a reservoir;

a conduit connected to a lower portion of the reservoir;

a dispenser defining an interior volume and containing therein a feed pipe, the feed pipe, having a first end in communication with the conduit and a second end defining a terminal curved elbow;

a lever secured within the dispenser and having a pivot, the lever engaging the feed pipe;

a linkage member connected at a first end to the lever and in communication on a second end with a solenoid;

wherein, when the solenoid is activated, the feed pipe is moved by the lever and pivoted from a first position to a second position, the second position allowing a controlled volume of a mixture within the feed pipe to be dispensed from the elbow, the mixture exiting the hopper via an exit spout.

It is another aspect of at least one embodiment of the invention to provide a dispenser wherein an interior of the reservoir further defines a pair of stops the feed pipe resting therebetween, the first stop member engaging the feed pipe when the feed pipe is in a non-dispensing position and the second stop member engaging the feed pipe when the feed pipe is in a dispensing position.

It is another aspect of at least one embodiment of the invention to provide a dispensing device according to claim 1 wherein there is a conveyor system containing a plurality of receptacles situated below the dispensing device.

It is another aspect of at least one embodiment of the invention to provide a dispensing device wherein the solenoid is actuated by a photo sensor, the photo sensor detecting a proper position of a receptacle beneath the exit spout for delivering the dry mixture.

It is another aspect of at least one embodiment of the invention to provide a dispensing device wherein the elbow is adapted for receiving a smaller diameter cylinder therein which will restrict the volume of material discharged from the terminal end of the elbow.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a view of the complete dispenser including the material reservoir and pots on the conveyor.

FIG. 2 is an internal view of the dispenser mechanism in FIG. 1.

FIG. 3 shows FIG. 2 with a cross section of the mechanism with material in the dispenser pipe.

FIG. 4 shows momentary actuation of the dispenser pipe releasing its measured quantity of material.

FIG. 5 is a view of FIG. 3 with a dose restriction cylinder inserted in the dispenser pipe.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

It is to, be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

As used herein, the term “effective amount” or “about” means a value of plus or minus 10 percent of the stated value unless a different specific value or range is provided.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

The present invention will now be described in more detail with reference to the accompanying drawings. Like numbers refer to like elements throughout the drawings and text.

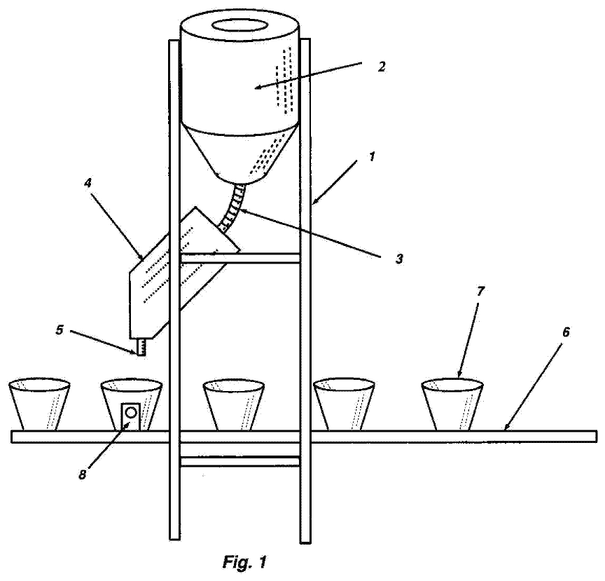

FIG. 1 illustrates the salient components of the automated material dispenser. As shown, the dispenser comprises a structural stand 1, a material reservoir 2 and a flexible hose 3 to feed material to the dispenser mechanism 4. The dispenser mechanism includes an exit spout 5 positioned over a conveyor 6 containing pots 7. As the pots move along the conveyor 6 a photo-detector 8 activates the dispenser 4 to eject a measured dose of the material through the exit spout 5 into the pot directly beneath the exit spout.

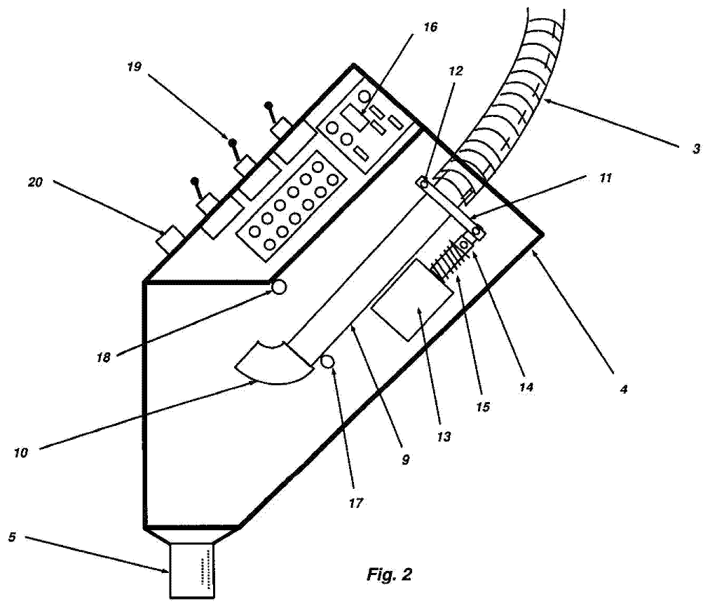

FIG. 2 shows a detail drawing of the dispenser unit 4 with the attached flexible feed pipe 3. Within the dispenser unit is a feed pipe 9 with an attached elbow 10 which can rotate about an axis 12 between a lower stop 17 and an upper stop 18. The feed pipe 9 is rigidly attached to a lever 11 which pivots on the axis 12. The free end of the lever 11 is attached to the spring loaded armature 15 of a pull type solenoid 13 through a linkage 14. This mechanism allows the feed pipe 9 to pivot upward the to top stop 18 when the solenoid 13 is actuated.

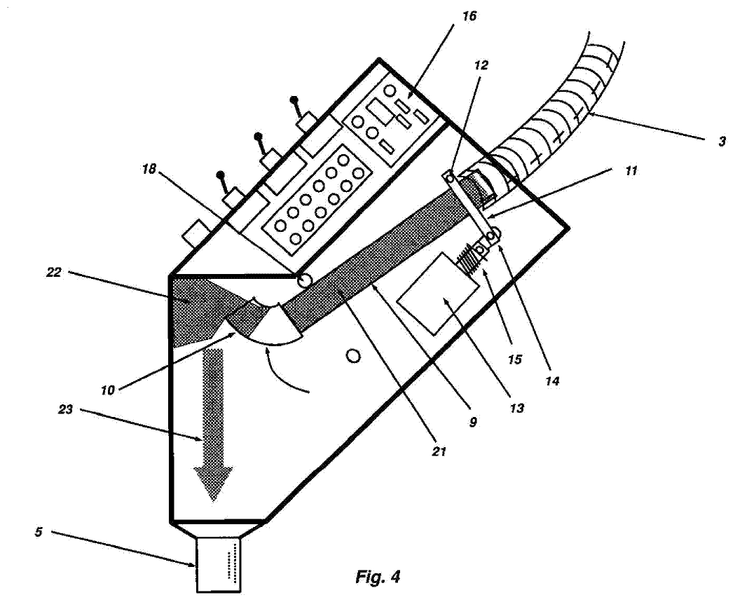

The solenoid 13 is controlled through a set of switches 19 by an electronic circuit board 16. The actuation sequence is initiated through the photo-detector connector 20. Multiple shots (actuations of the solenoid 13) can be controlled by the switches 19 for one pot as seen in FIG. 4. Also not shown is a conventional power supply, connection.

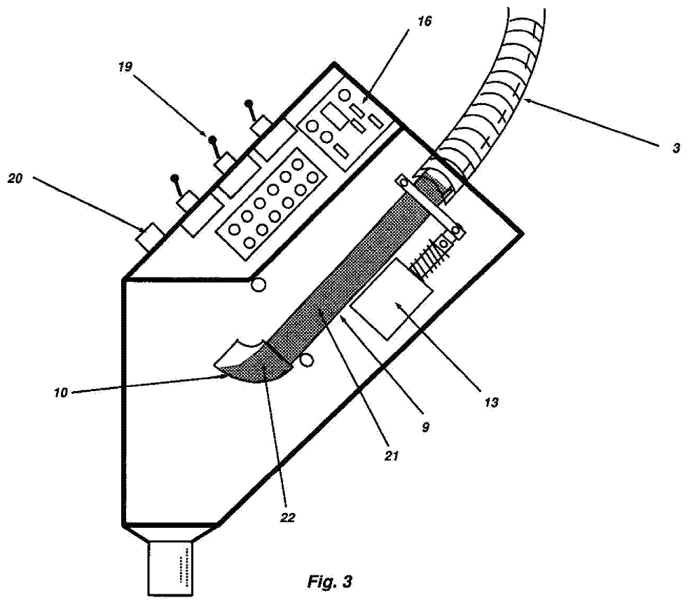

The operation of the dispenser will now be described referring to FIG. 3 and FIG. 4. FIG. 3 shows the dispenser mechanism in its home position not being activated. Material 21 and 22 has flowed down the flexible hose 3 to fill the feed pipe 9 and the elbow 10. Note that the material 22 does not spill out of the elbow 10. The angle of the elbow and the dimensions of the elbow may be varied depending upon the texture, density and other properties of the material.

FIG. 4 shows the mechanism in an actuated state. The pull solenoid 13 has been actuated so that the spring loaded armature 15 is fully pulled in causing the lever 11 and pipe 9 to be rapidly rotated along pivot arms 12 to the top stop 18. Due to the rapid deceleration of the feed pipe 9 and elbow 10 when striking stop 18, the material 22 contained in the elbow 10 is thrown upward and out of the elbow 10. The material 22 and 23 locations then falls downward and out of the dispenser exit spigot 5.

At this point in the operation the electronics 16 deactivates the solenoid 13 and allows the feed pipe 9 and elbow 10 to return to the home position as shown in FIG. 3. The material 21 and 22 locations rapidly refills the elbow 10 as shown in FIG. 3. This complete operation is fast enough to allow multiple shots within one second.

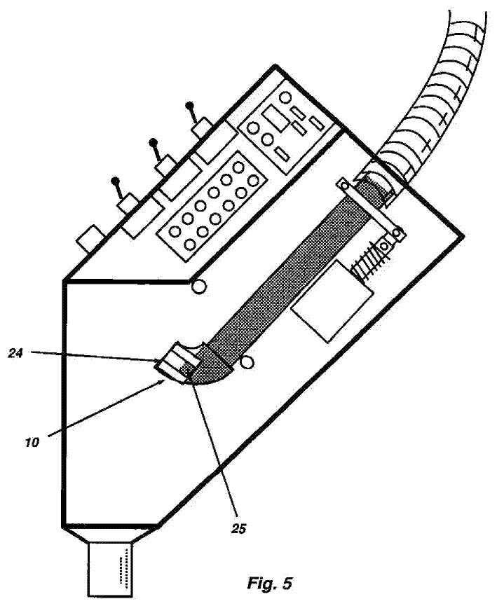

The amount of material 22 dispensed per shot is accurately controlled by the inside diameter of the elbow 10. This diameter can be changed so that the amount of material dispensed per shot can be varied. FIG. 5 shows a dose restriction cylinder 24 inserted and secured within the open end of the elbow 10. Note that now there is less material 25 that can escape during the dispensing cycle. The dispensing operation is identical to the unrestricted shown in FIG. 4 and FIG. 5.

This invention provides a simple mechanism for application of a measured amount of dry material to a localized area such as a potted plant. The mechanism will work with any granular material that will flow down a tube or hose. The mechanism is simple, consisting of two moving parts and does not contain any mechanically actuated valves which can clog or harm the dispensed material.

The mechanism comprises a material reservoir connected to an dispensing mechanism by a flexible hose. The material flows into the dispensing mechanism by gravity. The dispensing mechanism consists of an enclosure and a rigid feed pipe at about 45 degrees to horizontal which is able to rotate about an axis at one end. At the other end of the feed pipe an elbow is attached to allow material to fill the pipe and elbow, but not to overflow out of the pipe. The feed pipe and elbow are able to rotate upward through a few degrees controlled by stops.

A solenoid is connected to the feed pipe so that when actuated, the pipe rapidly rotates upward to the upper stop. When the pipe hits the stop a measured amount of material in the elbow is caused to be thrown upward out of the pipe and to exit the enclosure by gravity through an exit spout. At this point the solenoid is deactivated and returns to the bottom stop allowing more material to fill the elbow.

The solenoid is actuated by a photo detector and mirror assembly or by a manual contact switch. The detector is actuated when a pot breaks the photo-detector beam traveling by on a conveyor. An electronic circuit times pulses to the solenoid so that the feed pipe returns to it's home position rapidly after dispensing the material. The electronic circuit also allows multiple solenoid pulses (shots) for a single actuation in order to vary the amount of material dispensed. The amount of material dispensed in each shot is controlled by inserting a cylinder in the end of the elbow to restrict the inside diameter of the elbow, thus restricting the amount of material released in a shot.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. An automatic dispensing device for dispensing dry material, the device comprising:
a rigid pipe and elbow oriented at an angle to the horizontal able to be pivoted about an axis between two stops;
a solenoid for causing the pipe, and elbow via a lever to pivot between the stops when actuated;
A flexible hose to feed material into the pipe and elbow from a material reservoir;
an upper stop and lower stop situated such that material in the elbow will be expelled when the pivoting pipe hits the upper stop;
a photo-detector to detect pots or other containers moving by on a conveyor;
electronic circuitry to control the operation.
a removable dose restriction cylinder to change the inside diameter of the open of the elbow.

2. The dispensing device according to claim 1 wherein the rigid pipe and elbow is rotatable about an axis between a lower stop and an upper stop.

3. The dispensing device according to claim 1 an electric solenoid able to pivot the pipe and elbow about an axis through a lever and linkage. The solenoid being of such strength to rapidly rotate the pipe and elbow to the upper stop to expel material from the elbow when hitting the upper stop. Said material then exiting the device into a pot in proximity to the photo-detector.

4. The dispensing device according to claim 1 electronic means to control the duration of the actuation of the solenoid so that the pipe and elbow rapidly return to the lower stop.

5. The dispensing device according to claim 1 electronic means to vary the number of actuations of the solenoid so that multiple material doses can be dispensed per pot.

6. The dispensing device according to claim 1 a removable dose adjustment cylinder to change the inside diameter of the open end of the elbow to allow changing the amount of material dispensed per dose.

7. A dispensing device for dry material comprising:
a reservoir;
a conduit connected to a lower portion of the reservoir;
a dispenser defining an interior volume and containing therein a feed pipe, the feed pipe having a first end in communication with the conduit and a second end defining a terminal curved elbow;
a lever secured within the dispenser and having a pivot, the lever engaging the feed pipe;
a linkage member connected at a first end to the lever and in communication on a second end with a solenoid;
wherein, when the solenoid is activated, the feed pipe is moved by the lever and pivoted from a first position to a second position, the second position allowing a controlled volume of a mixture within the feed pipe to be dispensed from the elbow, the mixture exiting the hopper via an exit spout.

8. A dispenser according, to claim 7 wherein an interior of the reservoir further defines a pair of stops the feed pipe resting therebetween, the first stop member engaging the feed pipe when the feed pipe is in a non-dispensing position and the second stop member engaging the feed pipe when the feed pipe is in a dispensing position.

9. The dispensing device according to claim 1 wherein there is a conveyor system containing a plurality of receptacles situated below the dispensing device.

10. The dispensing device according to claim 7 wherein the solenoid is actuated by a photo sensor, the photo sensor detecting a proper position of a receptacle beneath the exit spout for delivering the dry mixture.

11. The dispensing device according to claim 7 wherein the elbow is adapted for receiving a smaller diameter cylinder therein which will restrict the volume of material discharged from the terminal end of the elbow.
